(19) United States
(12) Patent Application Publication
(10) Pub. No.: US 2007/0081526 A1
(43) Pub. Date: Apr. 12, 2007

(54) Network switch device

(75) Inventors: J.J. Young, Taipei City (TW); Chih-Chiang Lee, Hsinchu City (TW)

Correspondence Address: BIRCH STEWART KOLASCH & BIRCH, PO BOX 747, FALLS CHURCH, VA, 22040-0747, US

(73) Assignee: ACCTON TECHNOLOGY CORPORATION

(21) Appl. No.: 11/235,078

(22) Filed: Sep. 27, 2005

(51) Int. Cl. H04L 12/50; H04L 12/56

(52) U.S. Cl. 370/359; 370/419

(57) ABSTRACT

A network switch device includes a processor, a memory module, a PCI Bus, a switch fabric module, and an inspection module. In this case, memory module is cooperated with the processor. The switch fabric module has a plurality of first connecting terminals and connects to the processor through the PCI Bus. The inspection module has a plurality of second connecting terminals and a plurality of third connecting terminals. The second connecting terminals connect to the first connecting terminals respectively.

### BACKGROUND OF THE INVENTION

1. Field of Invention

The invention relates to a network switch device and, in particular, to a network switch device with the DPI (Deep Package Inspection) function.

2. Related Art

Internet has been widely spread in the recent years, and the whole network industry is greatly developed accordingly. For example, many new network communication apparatuses have been presented. Regarding to the LAN (Local Area Network), the network switch device is one of the necessary apparatuses for communicating the computers.

As shown in FIG. 1, a conventional network switch device 1 includes a plurality of connection ports 11, a plurality of physical layer modules 12, a switch fabric module 13, a processor 14, and a memory module 15. In this case, the connection ports 11 use an MII interface or a GMII interface to connect to the switch fabric module 13 through the physical layer module 12. The switch fabric module 13 further connects to the processor 14 with the PCI Bus. Moreover, the processor 14 cooperates with the memory module 15 to perform required calculations or operations. However, the architecture of the network switch device 1 does not provide the DPI function, so that the security requirement of the data package can not be satisfied.

Therefore, as shown in FIG. 2, the skilled person disclosed a network switch device 1′, which includes a DPI Engine 16 cooperating with the processor 14. After a data package enters the switch fabric module 13 from one connection port 11 through the corresponding physical layer module 12, it is transmitted to the processor 14 through the PCI Bus and then transmitted to the DPI Engine 16. In such a case, the data package can be inspected with the DPI Engine 16 so as to, for example, achieve the effect of Firewall, Anti-Virus, Anti-spam, or Content-Filtering. After inspected with the DPI Engine 16, the data package is transmitted back to the switch 13 through the processor 14 and the PCI Bus. Then, the data package can be transmitted from the switch 13 to another connection port 11 through the corresponding physical layer module 12, and be finally outputted via this connection port 11. However, the inspection of the data package is performed with the processor 14. In other words, if there are a plurality of data packages to be inspected before transmissions, the processor 14 must process all of the data packages. Thus, the loading of the processor 14 is greatly increased. As a result, the cost-benefit ratio increases and the performance of the processor 14 decreases. Besides, since the switch fabric module 13 switches the data package based on the package header including the physical layer, the data link layer, the network layer and the transport layer (OSI L1 to L4), it can only inspect the package header. In other words, the payload of the data package is usually not inspected.

Therefore, it is an important subject of the invention to provide a network switch device that can prevent consuming the performance of the processor.

### SUMMARY OF THE INVENTION

In view of the foregoing, the invention is to provide a network switch device that can prevent consuming the performance of the processor.

To achieve the above, a network switch device of the invention includes a processor, a memory module, a PCI Bus, a switch fabric module, and an inspection module. In the invention, the memory is cooperated with the processor. The switch fabric module has a plurality of first connecting terminals and connects to the processor through the PCI Bus. The inspection module has a plurality of second connecting terminals and third connecting terminals. The first connecting terminals connect to the second connecting terminals respectively. Accordingly, when a data package is inputted, it is then transmitted to the inspection module through the third connecting terminal. Thus, the inspection module can inspect the data package. In addition, when a data package is outputted, it is inspected with the inspection module in advance. In this case, the inspected data package is transmitted from the inspection module to a connection port via the third connecting terminal.

In addition, the invention also discloses a network switch device including a processor, a memory module, a PCI Bus, and a switch-inspection module. In the invention, the memory is cooperated with the processor. The switch-inspection module connects to the processor through the PCI Bus. Besides, the switch-inspection module has a plurality of first connecting terminals and a plurality of third connecting terminals. Herein, the switch-inspection module includes a switch fabric module and an inspection module. The switch fabric module has the first connecting terminals and connects to the processor through the PCI Bus. The inspection module has the third connecting terminals and a plurality of second connecting terminals for connecting to the first connecting terminals respectively.

As mentioned above, the network switch device of the invention provides an inspection module between the connection ports and the switch fabric module. Therefore, after being inputted to the network switch device or before being outputted from the network switch device, the data package can be inspected with the inspection module by way of, for example, deep package inspection (DPI). Furthermore, the processor is not involved in the inspection process, so that the consumption of the performance of the processor can be prevented and the requirement of security can be satisfied with the inspection process. As a result, the problems of the conventional network switch device, such as the higher cost-benefit ratio or the decreased performance of the processor, can be solved.

### BRIEF DESCRIPTION OF THE DRAWINGS

The invention will become more fully understood from the detailed description given herein below illustration only, and thus is not limitative of the present invention, and wherein:

FIG. 1 is a schematic view showing the architecture of the conventional network switch device;

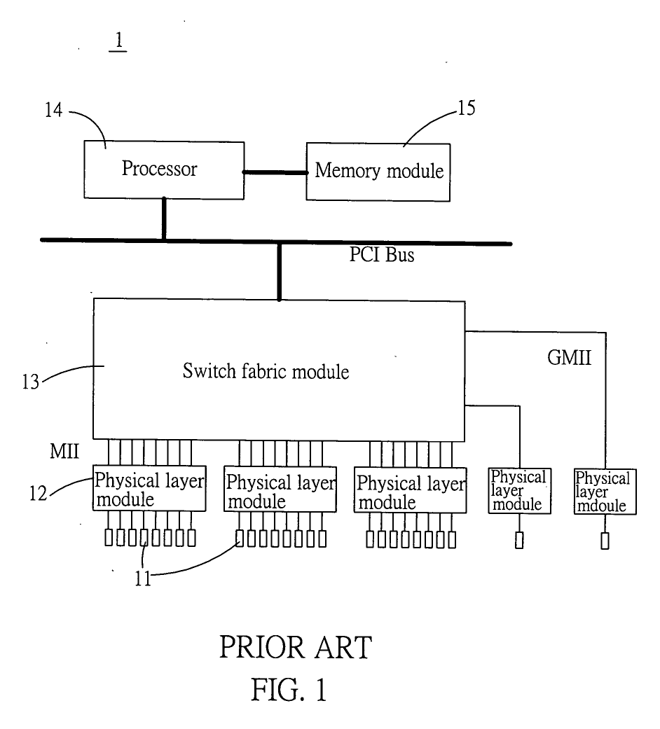

FIG. 2 is a schematic view showing the architecture of another conventional network switch device;

FIG. 3 is a schematic view showing the architecture of a network switch device according to a preferred embodiment of the invention; and

FIG. 4 is a schematic view showing the complete architecture of the network switch device according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

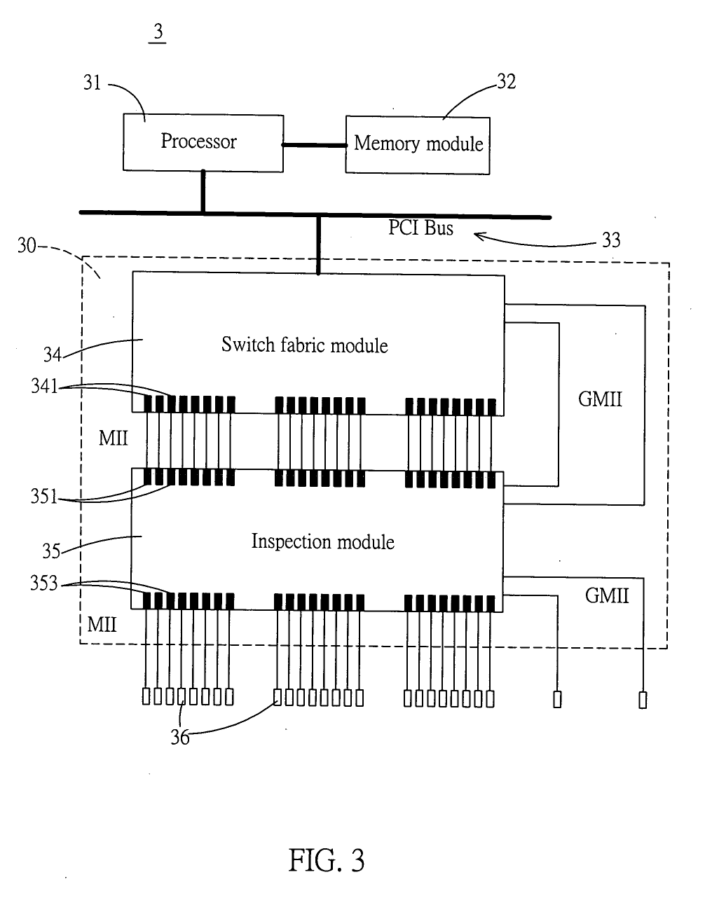

With reference to FIG. 3, a network switch device 3 according to a preferred embodiment of the invention includes a processor 31, a memory module 32, a PCI Bus 33, a switch fabric module 34, an inspection module 35, and a plurality of connection ports 36.

As shown in FIG. 3, the processor 31 connects to the switch fabric module 34 with the PCI Bus 33. Besides, the memory module 32 is cooperated with the processor 31 to perform the required calculation or operation. In this embodiment, the memory module 32 includes a flash memory and/or a SDRAM. Generally speaking, the flash memory usually stores firmware and the SDRAM usually stores software. Thus, the processor 31 can execute the firmware stored in the flash memory or the software stored in the SDRAM to perform the required calculation or operation.

In this embodiment, the switch fabric module 34 has a plurality of first connecting terminals 341, and the inspection module 35 has a plurality of second connecting terminals 351 and a plurality of third connecting terminals 353. As shown in FIG. 3, the first connecting terminals 341 are connected to the corresponding second connecting terminals 351, respectively. In the current embodiment, each second connecting terminal 351 is connected to the corresponding first connecting terminal 341 with an MII interface or a GMII interface.

As shown in FIG. 3, the connection ports 36 are used to connect to a network system such as the local area network (LAN), Internet, or the likes. Besides, the third connecting terminals 353 are connected to the corresponding connection ports 36, respectively. In the present embodiment, each third connecting terminal 353 is connected to the corresponding connection port 36 with an MII interface or a GMII interface. In this embodiment, the connection ports 36 can be any suitable port connectors such as the RJ-45 connectors.

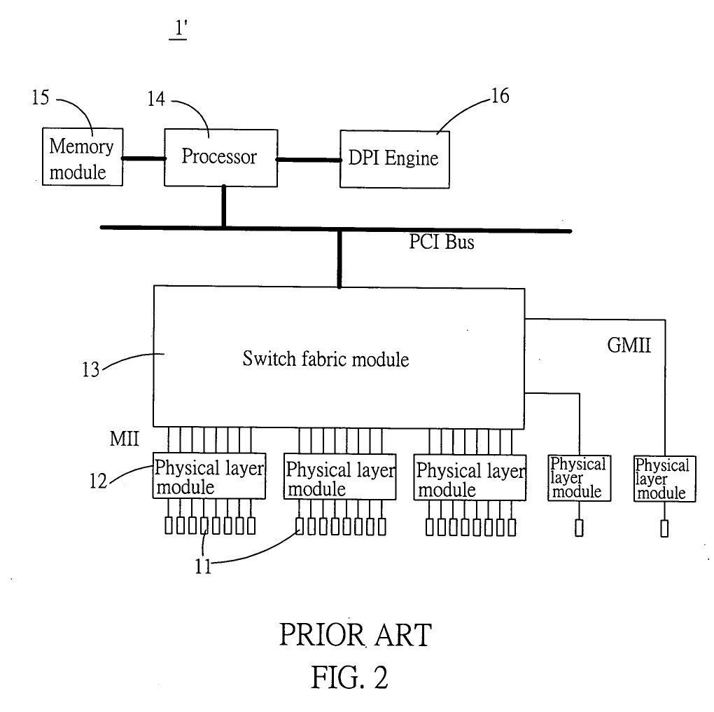

In the present embodiment, the inspection module 35 and the switch fabric module 34 of the invention are ASICs (Application-Specific Integrated Circuits). Alternatively, the inspection module 35 and the switch fabric module 34 of the invention can be integrated in a single ASIC, such as a switch-inspection module 30. Besides, the numbers of the connection ports 36, the third connecting terminals 353, the second connecting terminals 351 and the first connecting terminals 341 are substantially the same. For example, if the network switch device 3 has 26 connection ports 36, the inspection module 35 has 52 connecting terminals including 26 second connecting terminals 351 and 26 third connecting terminals 353. Similarly, the switch fabric module 34 has 26 first connecting terminals 341. Since the number of the terminals of the inspection module 35 is greater than that of the conventional DPI Engine 16, which has only one I/O port (shown in FIG. 2), the inspection speed can be greatly increased resulting in enhanced performance.

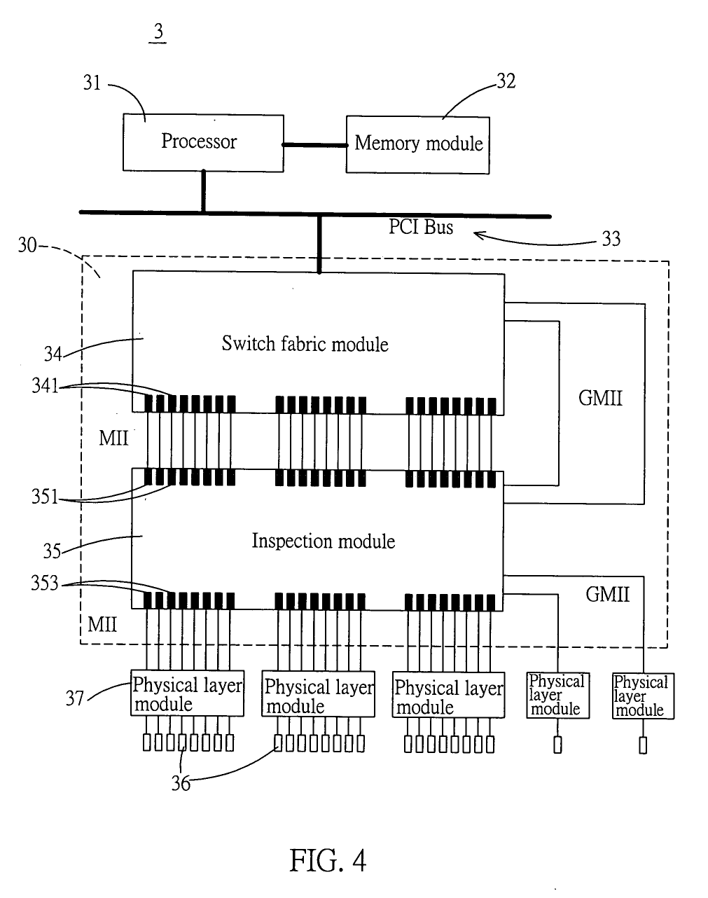

In addition, with reference to FIG. 4, the network switch device 3 according to the embodiment of the invention may further includes a plurality of physical layer modules 37.

As shown in FIG. 4, the physical layer modules 37 are installed between the connection ports 36 and the inspection module 35 or the switch-inspection module 30. In the present embodiment, each physical layer module 37 connects one or more connection ports 36 to corresponding one or more third connecting terminals 353. Accordingly, all third connecting terminals 353 can be connected to all connection ports 36 via the physical layer modules 37. In addition, each third connecting terminal 353 is connected to the physical layer module 37 with an MII interface or a GMII interface, and then connected to the corresponding connection port 36 through the physical layer module 37.

In this embodiment, when the network switch device 3 uses one connection port 36 to receive a data package, the data package is inputted from the connection port 36, then transmitted to the physical layer module 37, and then transmitted to the inspection module 35 with the MII interface or GMII interface through the corresponding third connecting terminal 353. After that, the inspection module 35 inspects the data package with a method of DPL Finally, the inspected data package is transmitted to the switch fabric module 34 with the MII interface or GMII interface through the corresponding second connecting terminal 351 and first connecting terminal 341. As being controlled by the switch fabric module 34, the data package can be outputted from another connection port 36.

Moreover, when the network switch device 3 uses the connection port 36 to output a data package, the data package is transmitted from the switch fabric module 34 to the inspection module 35 with the MII interface or GMII interface through the corresponding first connecting terminal 341 and second connecting terminal 351. After that, the inspection module 35 inspects the data package with a method of DPL Then, the inspected data package is transmitted from the inspection module 35 to the physical layer module 37 with the MII interface or GMII interface through the corresponding third connecting terminal 353. Finally, the data package is transmitted from the physical layer module 37 to the corresponding connection port 36, and is then outputted from the connection port 36. To be noted, since the inspection module 35 is disposed between the connection ports 36 and the switch fabric module 34, all data packages switched by the switch fabric module 34 can be inspected by DPI. In other words, the package header and the payload of the data package, which includes the physical layer, the data link layer, the network layer, the transport layer, the session layer, the presentation layer, and the application layer (OSI L1 to L7) can be all inspected.

In summary, the network switch device of the invention provides an inspection module between the connection ports and the switch fabric module. Therefore, after being inputted to the network switch device or before being outputted from the network switch device, the data package can be inspected with the inspection module by way of, for example, deep package inspection (DPI). Furthermore, the processor is unnecessary in the inspection process, so that the consumption of the performance of the processor can be prevented and the requirement of security can be satisfied with the inspection process. As a result, the problems of the conventional network switch device, such as the higher cost-benefit ratio or the decreased performance of the processor, can be solved.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A network switch device, comprising:
a processor;
a memory module, which is cooperated with the processor,
a Bus;
a switch fabric module, which has a plurality of first connecting terminals and connects to the processor through the Bus; and
an inspection module, which has a plurality of second connecting terminals and a plurality of third connecting terminals, wherein the second connecting terminals connect to the first connecting terminals respectively.

2. The network switch device of claim 1, further comprising:
a plurality of connection ports, which connect to the third connecting terminals respectively.

3. The network switch device of claim 2, wherein one of the connection ports is used to receive a data package, the data package is then transmitted to the inspection module through one of the third connecting terminals, and the inspection module inspects the data package.

4. The network switch device of claim 3, wherein the data package is transmitted to the switch fabric module through one of the second connecting terminals and one of the first connecting terminals, and the switch fabric module controls to output the data package from another one of the connection ports.

5. The network switch device of claim 3, wherein the inspection module inspects the data package by way of DPI (deep package inspection).

6. The network switch device of claim 2, wherein the switch fabric module transmits a data package to the inspection module through one of the first connecting terminals and one of the second connecting terminals, and the inspection module then inspects the data package.

7. The network switch device of claim 6, wherein the inspected data package is transmitted to one of the connection ports through one of the third connecting terminals so as to output the data package from the connection port.

8. The network switch device of claim 6, wherein the inspection module inspects the data package by way of DPI (Deep Package Inspection).

9. The network switch device of claim 2, further comprising:
at least one physical layer module, wherein the third connecting terminals are respectively connected to the connection ports via the physical layer module.

10. The network switch device of claim 9, wherein the third connecting terminals connects to the physical layer module with an MII (Media Independent Interface) or a GMII (Gigabit Media Independent Interface), and then respectively connects to the connection ports via the physical layer module.

11. The network switch device of claim 2, wherein the connection ports are RJ-45 connectors.

12. The network switch device of claim 1, wherein the first connecting terminals respectively connects to the second connecting terminals with an MII (Media Independent Interface) or a GMII (Gigabit Media Independent Interface).

13. The network switch device of claim 1, wherein each of the inspection module and the switch fabric module is an ASIC (Application-Specific Integrated Circuit).

14. The network switch device of claim 1, wherein the inspection module and the switch fabric module are integrated in an ASIC (Application-Specific Integrated Circuit).

15. The network switch device of claim 1, wherein the memory module comprises a flash memory and a SDRAM for storing firmware or software.

16. The network switch device of claim 1, wherein the Bus is a PCI Bus.

17. A network switch device, comprising:
a processor;
a memory module, which is cooperated with the processor,
a Bus; and
a switch-inspection module, which has a plurality of third connecting terminals, wherein the switch-inspection module connects to the processor through the Bus.

18. The network switch device of claim 17, wherein the switch-inspection module comprises:
a switch fabric module, which has a plurality of first connecting terminals and connects to the processor through the Bus; and
an inspection module, which has a plurality of second connecting terminals and the third connecting terminals, wherein the second connecting terminals connect to the first connecting terminals respectively.

19. The network switch device of claim 18, wherein the first connecting terminals respectively connects to the second connecting terminals with an MII (Media Independent Interface) or a GMII (Gigabit Media Independent Interface).

20. The network switch device of claim 17, further comprising:
a plurality of connection ports, which connect to the third connecting terminals respectively.

21. The network switch device of claim 20, wherein one of the connection ports is used to receive a data package, the data package is then transmitted to the switch-inspection module through one of the third connecting terminals, and the switch-inspection module inspects the data package and controls to output the data package from another one of the connection ports.

22. The network switch device of claim 21, wherein the switch-inspection module inspects the data package by way of DPI (deep package inspection).

23. The network switch device of claim 20, further comprising:
at least one physical layer module, wherein the third connecting terminals are respectively connected to the connection ports via the physical layer module.

24. The network switch device of claim 23, wherein the third connecting terminals connects to the physical layer module with an MII (Media Independent Interface) or a GMII (Gigabit Media Independent Interface), and then respectively connects to the connection ports via the physical layer module.

25. The network switch device of claim 20, wherein the connection ports are RJ-45 connectors.

26. The network switch device of claim 17, wherein the switch-inspection module is an ASIC (Application-Specific Integrated Circuit).

27. The network switch device of claim 17, wherein the memory module comprises a flash memory and a SDRAM for storing firmware or software.

28. The network switch device of claim 17, wherein the Bus is a PCI Bus.
